(19) United States
(12) Patent Application Publication
(10) Pub. No.: US 2025/0336181 A1
(43) Pub. Date: Oct. 30, 2025

(54) COMBINING DEEP LEARNING MODEL HIDDEN LAYER OUTPUT WITH SPECIMEN-SPECIFIC INPUT FOR DEFECT CLASSIFICATION OR ANOTHER SEMICONDUCTOR APPLICATION

(71) Applicant: KLA Corporation, Milpitas, CA (US)

(72) Inventors: Jason Kirkwood, Mountain View, CA (US); Jan Lauber, San Francisco, CA (US)

(21) Appl. No.: 18/735,144

(22) Filed: Jun. 5, 2024

Related U.S. Application Data
(60) Provisional application No. 63/638,413, filed on Apr. 25, 2024.

(51) Int. Cl. G06V 10/764; G06V 10/77; G06V 10/82; G06V 10/98

(52) U.S. Cl. CPC G06V 10/764; G06V 10/7715; G06V 10/82; G06V 10/993; G06V 2201/06

(57) ABSTRACT

Methods and systems for determining information for a specimen are provided. One system includes one or more components executed by a computer system including a deep learning (DL) model configured for determining information for a specimen from output generated for the specimen by at least one of one or more detectors of an output generation subsystem. The DL model includes hidden layers configured for generating hidden layer output. The one or more components also include an additional component configured for determining additional information for the specimen from the hidden layer output generated by at least one of the hidden layers in combination with input specific to the specimen. In some embodiments, the information of the first DL and its hidden layer are used as inputs to a second network that then also uses non-image based information of the defects to further distill the purity of DOI vs nuisance separation.

### BACKGROUND OF THE INVENTION

### 1. Field of the Invention

The present invention generally relates to methods and systems for determining information for a specimen. Certain embodiments relate to defect classification or determining some other information for a specimen from hidden layer output generated by at least one hidden layer in a deep learning (DL) model in combination with input specific to the specimen.

### 2. Description of the Related Art

The following description and examples are not admitted to be prior art by virtue of their inclusion in this section.

Fabricating semiconductor devices such as logic and memory devices typically includes processing a substrate such as a semiconductor wafer using a large number of semiconductor fabrication processes to form various features and multiple levels of the semiconductor devices. For example, lithography is a semiconductor fabrication process that involves transferring a pattern from a reticle to a resist arranged on a semiconductor wafer. Additional examples of semiconductor fabrication processes include, but are not limited to, chemical-mechanical polishing (CMP), etch, deposition, and ion implantation. Multiple semiconductor devices may be fabricated in an arrangement on a single semiconductor wafer and then separated into individual semiconductor devices.

Inspection processes are used at various steps during a semiconductor manufacturing process to detect defects on specimens to drive higher yield in the manufacturing process and thus higher profits. Inspection has always been an important part of fabricating semiconductor devices. However, as the dimensions of semiconductor devices decrease, inspection becomes even more important to the successful manufacture of acceptable semiconductor devices because smaller defects can cause the devices to fail.

Defect review typically involves re-detecting defects detected as such by an inspection process and generating additional information about the defects at a higher resolution using either a high magnification optical system or a scanning electron microscope (SEM). Defect review is therefore performed at discrete locations on specimens where defects have been detected by inspection. The higher resolution data for the defects generated by defect review is more suitable for determining attributes of the defects such as profile, roughness, more accurate size information, etc. Defects can generally be more accurately classified into defect types based on information determined by defect review compared to inspection.

Metrology processes are also used at various steps during a semiconductor manufacturing process to monitor and control the process. Metrology processes are different than inspection processes in that, unlike inspection processes in which defects are detected on a specimen, metrology processes are used to measure one or more characteristics of the specimen that cannot be determined using currently used inspection tools. For example, metrology processes are used to measure one or more characteristics of a specimen such as a dimension (e.g., line width, thickness, etc.) of features formed on the specimen during a process such that the performance of the process can be determined from the one or more characteristics. In addition, if the one or more characteristics of the specimen are unacceptable (e.g., out of a predetermined range for the characteristic(s)), the measurements of the one or more characteristics of the specimen may be used to alter one or more parameters of the process such that additional specimens manufactured by the process have acceptable characteristic(s).

Metrology processes are also different than defect review processes in that, unlike defect review processes in which defects that are detected by inspection are re-visited in defect review, metrology processes may be performed at locations at which no defect has been detected. In other words, unlike defect review, the locations at which a metrology process is performed on a specimen may be independent of the results of an inspection process performed on the specimen. In particular, the locations at which a metrology process is performed may be selected independently of inspection results. In addition, since locations on the specimen at which metrology is performed may be selected independently of inspection results, unlike defect review in which the locations on the specimen at which defect review is to be performed cannot be determined until the inspection results for the specimen are generated and available for use, the locations at which the metrology process is performed may be determined before an inspection process has been performed on the specimen.

Methods and systems configured for performing the yield related processes described above are often developed by first finding the best possible hardware configuration for generating images, data, measurements, signals, etc. for the specimens. Once the hardware configuration has been established, parameters of the hardware that are best for the processes are selected. Hardware parameter selection can greatly affect how responsive the images, data, measurements, signals, etc. are to the specimen and how well they can be used for determining information for the specimen.

Sometimes even the best possible hardware configuration and associated parameters are not capable of generating output that is ideal (or even good enough) for determining information for a specimen. For example, in the case of inspection, the best possible hardware configuration and parameters may still produce a significant number of detected nuisances, which have to be accurately separated from defects of interest (DOIs) in order for the inspection results to be useful. This task is often referred to as nuisance filtering or more generally a type of defect classification. And while the task may seem simple enough, it can be difficult for a number of reasons such as, but not limited to, unfortunate similarities between the images and/or signals of nuisances and DOIs and extremely limited numbers of DOI examples available for suitable training of the nuisance filtering (or defect classification) algorithms, models, components, etc.

Much work has therefore been done in the industry to develop successful nuisance filtering approaches, which has led to myriad different kinds of algorithms, models, etc., each of which can also have a significant number of parameters that have to be established for specific specimens, DOIs, nuisances, and any other aspect of the inspection process that can affect the results. Some examples of currently used methods include those that use decision trees and random forest (RF) classifiers to separate the DOIs from nuisance defects (NUI). More recently, image-based neural network (NN) methods have been developed that can be successful at separating DOI from NUI by, for example, teasing apart subtle differences in the defect patch images.

There remain, however, a number of disadvantages to even the most successful nuisance filters and defect classifiers. For example, while RF methods are an improvement over simple decision trees, both methods lack the ability to directly use image information, i.e., the images cannot be input to the RF methods or decision trees. Such methods can also be prohibitively complicated and time-consuming to set up. In another example, NN methods usually require a substantial amount of labelled data for training. While excellent at teasing out subtle differences in the images, they lack the ability to use as input wafer-level information such as regions, image segmentation, and other defect detection algorithm related quantities.

Marginalities in the defect classification can have serious consequences for manufacture of the devices on the specimen. For example, any inaccuracy in the defect classification can result in delays in the process control of the chip manufacturing, which can be substantially costly for chip manufacturers.

Accordingly, it would be advantageous to develop systems and methods for determining information for a specimen that do not have one or more of the disadvantages described above.

### SUMMARY OF THE INVENTION

The following description of various embodiments is not to be construed in any way as limiting the subject matter of the appended claims.

One embodiment relates to a system configured for determining information for a specimen. The system includes a computer system configured for acquiring output generated for a specimen by one or more detectors of an output generation subsystem. The system also includes one or more components executed by the computer system. The one or more components include a deep learning (DL) model configured for determining information for the specimen from the output generated by at least one of the one or more detectors. The DL model includes hidden layers configured for generating hidden layer output. The component(s) also include an additional component configured for determining additional information for the specimen from the hidden layer output generated by at least one of the hidden layers in combination with input specific to the specimen. The system may be further configured as described herein.

Another embodiment relates to a computer-implemented method for determining information for a specimen. The method includes acquiring output generated for a specimen by one or more detectors of an output generation subsystem. The method also includes determining information for the specimen from the output generated by at least one of the one or more detectors with a DL model that includes hidden layers configured for generating hidden layer output. The method further includes determining additional information for the specimen by inputting the hidden layer output generated by at least one of the hidden layers in combination with input specific to the specimen into an additional component. The DL model and the additional component are included in one or more components executed by a computer system.

Each of the steps of the method may be performed as described further herein. The method may include any other step(s) of any other method(s) described herein and may be performed by any of the systems described herein.

Another embodiment relates to a non-transitory computer-readable medium storing program instructions executable on a computer system for performing a computer-implemented method for determining information for a specimen. The computer-implemented method includes the steps of the method described above. The computer-readable medium may be further configured as described herein. The steps of the computer-implemented method may be performed as described further herein. In addition, the computer-implemented method for which the program instructions are executable may include any other step(s) of any other method(s) described herein.

### BRIEF DESCRIPTION OF THE DRAWINGS

Further advantages of the present invention will become apparent to those skilled in the art with the benefit of the following detailed description of the preferred embodiments and upon reference to the accompanying drawings in which:

FIGS. 1 and 2 are schematic diagrams illustrating side views of embodiments of a system configured as described herein;

FIG. 3 is a schematic diagram illustrating an example of the data flow in a deep learning (DL) neural network (NN) configured for separating nuisance defects (NUI) from defects of interest (DOI);

FIG. 4 is a schematic diagram illustrating an embodiment of a configuration and data flow of a DL model and an additional component configured for determining information for a specimen from hidden layer output of a hidden layer of the DL model in combination with input specific to the specimen; and

FIG. 5 is a block diagram illustrating one embodiment of a non-transitory computer-readable medium storing program instructions for causing a computer system to perform a computer-implemented method described herein.

While the invention is susceptible to various modifications and alternative forms, specific embodiments thereof are shown by way of example in the drawings and are herein described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

Turning now to the drawings, it is noted that the figures are not drawn to scale. In particular, the scale of some of the elements of the figures is greatly exaggerated to emphasize characteristics of the elements. It is also noted that the figures are not drawn to the same scale. Elements shown in more than one figure that may be similarly configured have been indicated using the same reference numerals. Unless otherwise noted herein, any of the elements described and shown may include any suitable commercially available elements.

In general, the embodiments described herein are configured for determining information for a specimen. Although some embodiments may be described herein with respect to defect classification, as also described herein, the embodiments are not limited to such specimen information determinations. Classifying defects generally includes determining a type of a detected defect. Classifying defects may also be referred to as “binning” defects. Classifying defects is often performed after defect detection and nuisance filtering although that is not necessary. For example, in the broadest term definition, classifying defects may include nuisance filtering. In this manner, classifying defects, as that term is used herein, may be just filtering nuisances from detected defects and/or (or at least) separating defects into different bins corresponding to different types of defects, e.g., a bridge type defect, a missing pattern type defect, etc.

One particularly advantageous configuration of the embodiments described herein is cascading neural network (NN) and random forest (RF) for improved defect classification. The application of machine learning (ML) algorithms in binning and classification of defects has been well established and is a very important step in defect detection processes performed by tools such as those described further herein. Accurate defect classification is essential for the semiconductor industry to control the manufacturing process.

Several methods have been well established and are routinely applied such as decision trees, RFs, or deep learning (DL) neural networks (DL NN). Each of these methods have their strengths and weaknesses. Simple decision trees are based on defect attributes extracted from the inspection recipe, detection algorithms as well as the brightness and shape of the defects. These decision trees can be strengthened by using multiple such trees in an RF method. On the other hand, DL networks are completely image based and do not use any wafer level information such as die region or image segmentation.

A combination of the RF decision method and the image-based DL network can leverage the strengths of both individual methods. In some of the embodiments described herein, a DL NN gets applied to defect patch images first. The output of at least one hidden layer in the NN is then used as input to a subsequent RF. The combination of the two methods improves the classification accuracy of the detected defects significantly, which is of substantially high value to users of inspection tools such as those described herein.

The term “detected defect” as used herein is interchangeable with “detected event,” both of which are used to refer to defects detected on a specimen that may or may not be actual defects on the specimen. “Detected defects” are also commonly referred to in the art as “potential defects” or “defect candidates.” Once a detected defect has been confirmed as an actual defect, e.g., by one or more of nuisance filtering, defect classification, defect review, etc., it is more commonly referred to simply as a “defect” or “actual defect.”

“Nuisances” (which is sometimes used interchangeably with “nuisance defects”) as that term is used herein is generally defined as defects that a user does not care about and/or events that are detected on a specimen but are not really actual defects on the specimen. Nuisances (NUI) that are not actually defects may be detected as events due to non-defect noise sources on a specimen (e.g., grain in metal lines on the specimen, signals from underlaying layers or materials on the specimen, line edge roughness (LER), relatively small critical dimension (CD) variation in patterned attributes, thickness variations, etc.) and/or due to marginalities in the inspection system itself or its configuration used for inspection.

The term “defects of interest (DOIs)” as used herein is defined as defects that are detected on a specimen and are really actual defects on the specimen. Therefore, the DOIs are of interest to a user because users generally care about how many and what kind of actual defects are on specimens being inspected. In some contexts, the term “DOI” is used to refer to a subset of all of the actual defects on the specimen, which includes only the actual defects that a user cares about. For example, there may be multiple types of DOIs on any given specimen, and one or more of them may be of greater interest to a user than one or more other types. In the case of nuisance filtering, all non-nuisances may be considered DOIs whereas in defect classification only some of the defect types may be considered DOIs.

In some embodiments, the specimen is a wafer. The wafer may include any wafer known in the semiconductor arts. Although some embodiments may be described herein with respect to a wafer or wafers, the embodiments are not limited in the specimens for which they can be used. For example, the embodiments described herein may be used for specimens such as reticles, flat panels, personal computer (PC) boards, and other semiconductor specimens.

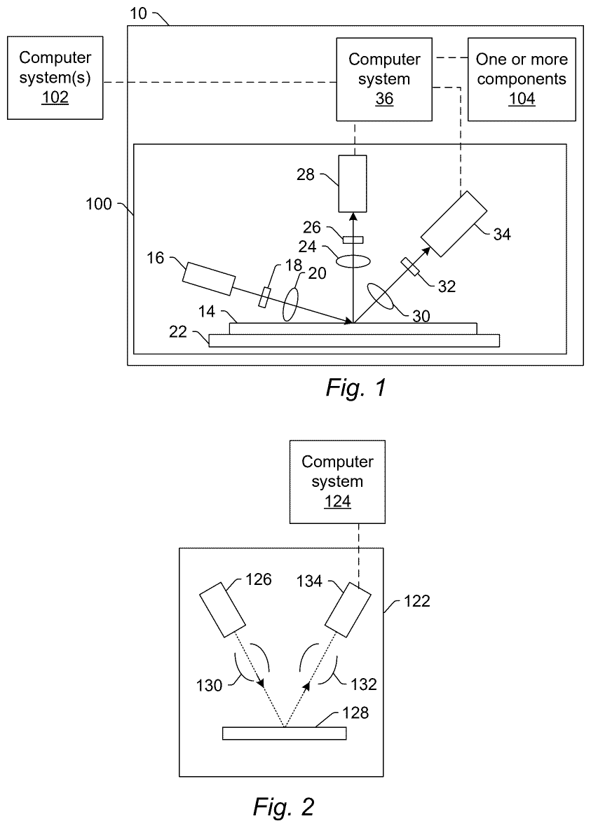

One embodiment of a system configured for determining information for a specimen is shown in FIG. 1. In some embodiments, system 10 includes an output generation subsystem, which may be configured as imaging system 100. The imaging system includes and/or is coupled to a computer system, e.g., computer system 36 and/or one or more computer systems 102. In general, the output generation systems described herein include at least an energy source, a detector, and a scanning subsystem. The energy source is configured to generate energy that is directed to a specimen by the output generation system. The detector is configured to detect energy from the specimen and to generate output responsive to the detected energy. The scanning subsystem is configured to change a position on the specimen to which the energy is directed and from which the energy is detected.

In output generation subsystems configured as or including a light-based imaging system, the energy directed to the specimen includes light, and the energy detected from the specimen includes light. For example, as shown in FIG. 1, the imaging system includes an illumination subsystem configured to direct light to specimen 14. The illumination subsystem includes at least one light source, e.g., light source 16. The illumination subsystem is configured to direct the light to the specimen at one or more angles of incidence, which may include one or more oblique angles and/or one or more normal angles. For example, as shown in FIG. 1, light from light source 16 is directed through optical element 18 and then lens 20 to specimen 14 at an oblique angle of incidence. The oblique angle of incidence may include any suitable oblique angle of incidence, which may vary depending on, for instance, characteristics of the specimen and the process being performed on the specimen.

The illumination subsystem may be configured to direct the light to the specimen at different angles of incidence. For example, the imaging subsystem may be configured to alter one or more characteristics of one or more elements of the illumination subsystem such that the light can be directed to the specimen at an angle of incidence that is different than that shown in FIG. 1. In one such example, the imaging subsystem may be configured to move light source 16, optical element 18, and lens 20 such that the light is directed to the specimen at a different oblique angle of incidence or a normal (or near normal) angle of incidence. The illumination subsystem may have any other suitable configuration known in the art for directing the light to the specimen at one or more angles of incidence sequentially or simultaneously.

The illumination subsystem may also be configured to direct light with different characteristics to the specimen. For example, optical element 18 may be configured as a spectral filter and the properties of the spectral filter can be changed in a variety of different ways (e.g., by swapping out one spectral filter with another) such that different wavelengths of light can be directed to the specimen at different times.

Light source 16 may include a broadband plasma (BBP) light source. In this manner, the light generated by the light source and directed to the specimen may include broadband light. However, the light source may include any other suitable light source such as any suitable laser known in the art configured to generate light at any suitable wavelength(s). In addition, the laser may be configured to generate light that is monochromatic or nearly-monochromatic. In this manner, the laser may be a narrowband laser. The light source may also include a polychromatic light source that generates light at multiple discrete wavelengths or wavebands.

Light from optical element 18 may be focused onto specimen 14 by lens 20. Although lens 20 is shown in FIG. 1 as a single refractive optical element, in practice, lens 20 may include a number of refractive and/or reflective optical elements that in combination focus the light from the optical element to the specimen. The illumination subsystem shown in FIG. 1 and described herein may include any other suitable optical elements (not shown). Examples of such optical elements include, but are not limited to, polarizing component(s), spectral filter(s), spatial filter(s), reflective optical element(s), apodizer(s), beam splitter(s), aperture(s), and the like, which may include any such suitable optical elements known in the art. In addition, the system may be configured to alter one or more elements of the illumination subsystem based on the type of illumination to be used for imaging.

The imaging system may also include a scanning subsystem configured to cause the light to be scanned over the specimen. For example, the imaging system may include stage 22 on which specimen 14 is disposed during imaging. The scanning subsystem may include any suitable mechanical and/or robotic assembly (that includes stage 22) that can be configured to move the specimen such that the light can be directed to and detected from different positions on the specimen. In addition, or alternatively, the imaging system may be configured such that one or more optical elements of the imaging system perform some scanning of the light over the specimen such that the light can be directed to and detected from different positions on the specimen. The light may be scanned over the specimen in any suitable fashion such as in a serpentine-like path or in a spiral path.

The imaging system further includes one or more detection channels. At least one of the detection channel(s) includes a detector configured to detect light from the specimen due to illumination of the specimen by the imaging system and to generate output responsive to the detected light. For example, the imaging system shown in FIG. 1 includes two detection channels, one formed by collector 24, element 26, and detector 28 and another formed by collector 30, element 32, and detector 34. As shown in FIG. 1, the two detection channels are configured to collect and detect light at different angles of collection. In some instances, both detection channels are configured to detect scattered light, and the detection channels are configured to detect light that is scattered at different angles from the specimen. However, one or more of the detection channels may be configured to detect another type of light from the specimen (e.g., reflected light).

As further shown in FIG. 1, both detection channels and the illumination subsystem are positioned in the plane of the paper. Therefore, in this embodiment, both detection channels are positioned in (e.g., centered in) the plane of incidence. However, one or more of the detection channels may be positioned out of the plane of incidence. For example, the detection channel formed by collector 30, element 32, and detector 34 may be configured to collect and detect light that is scattered out of the plane of incidence. Therefore, such a detection channel may be commonly referred to as a “side” channel, and such a side channel may be centered in a plane that is substantially perpendicular to the plane of incidence.

Although FIG. 1 shows an embodiment of the imaging system that includes two detection channels, the imaging system may include a different number of detection channels (e.g., only one detection channel or two or more detection channels). In one such instance, the detection channel formed by collector 30, element 32, and detector 34 may form one side channel as described above, and the imaging system may include an additional detection channel (not shown) formed as another side channel that is positioned on the opposite side of the plane of incidence. Therefore, the imaging system may include the detection channel that includes collector 24, element 26, and detector 28 and that is centered in the plane of incidence and configured to collect and detect light at scattering angle(s) that are at or close to normal to the specimen surface. This detection channel may therefore be commonly referred to as a “top” channel, and the imaging system may also include two or more side channels configured as described above. As such, the imaging system may include at least three channels (i.e., one top channel and two side channels), and each of the at least three channels has its own collector, each of which is configured to collect light at different scattering angles than each of the other collectors.

As described further above, each of the detection channels included in the imaging system may be configured to detect scattered light. Therefore, the imaging system shown in FIG. 1 may be configured for dark field (DF) imaging of specimens. In this manner, the imaging system may be configured as a light scattering (LS) DF inspection system. However, the imaging system may also or alternatively include detection channel(s) that are configured for bright field (BF) imaging of specimens. In other words, the imaging system may include at least one detection channel that is configured to detect light specularly reflected from the specimen. Therefore, the imaging systems described herein may be configured for only DF, only BF, or both DF and BF imaging. Although each of the collectors are shown in FIG. 1 as single refractive optical elements, each of the collectors may include one or more refractive optical elements and/or one or more reflective optical elements.

The one or more detection channels may include any suitable detectors known in the art such as photo-multiplier tubes (PMTs), charge coupled devices (CCDs), and time delay integration (TDI) cameras. The detectors may also include non-imaging detectors or imaging detectors. Non-imaging detectors are configured to detect certain characteristics of the scattered light such as intensity but not to detect such characteristics as a function of position within the imaging plane. As such, the output that is generated by each of the detectors included in each of the detection channels may be signals or data, but not image signals or image data. In such instances, a computer system such as computer system 36 may generate images of the specimen from the non-imaging output of the detectors. However, in other instances, the detectors may be configured as imaging detectors that are configured to generate imaging signals or image data. Therefore, the imaging system may be configured to generate images in a number of ways.

Computer system 36 may be coupled to the detectors of the output generation subsystem in any suitable manner (e.g., via one or more transmission media, which may include “wired” and/or “wireless” transmission media) such that the computer system can receive the output generated by the detectors. Computer system 36 may be configured to perform a number of functions using the output of the detectors. For instance, if the system is configured as an inspection system, the computer system may be configured to detect defects on the specimen using the output of the detectors. Detecting the defects on the specimen may be performed in any suitable manner such as by inputting the detector output into a defect detection algorithm or method. In perhaps the most simple implementation, a defect detection algorithm or method may apply a threshold to the detector output and determine that any output, signal, etc. having a value above the threshold is a defect or potential defect. However, the embodiments described herein may be configured for using any defect detection algorithm or method known in the art for detecting defects on a specimen.

Computer system 36 may be further configured as described herein. For example, computer system 36 may be configured to perform the steps described herein. As such, the steps described herein may be performed “on-tool,” by a computer system that is coupled to or part of an imaging system. In addition, or alternatively, computer system(s) 102 may perform one or more of the steps described herein. Therefore, one or more of the steps described herein may be performed “off-tool,” by a computer system that is not directly coupled to an imaging system.

Computer system 36 (as well as other computer systems described herein) may also be referred as computer subsystem(s). Each of the computer subsystem(s) or system(s) may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The computer subsystem(s) or system(s) may also include any suitable processor known in the art such as a parallel processor. In addition, the computer subsystem(s) or system(s) may include a computer platform with high speed processing and software, either as a standalone or a networked tool.

If the system includes more than one computer system, then the different computer systems may be coupled to each other such that images, data, information, instructions, etc. can be sent between the computer systems. For example, computer system 36 may be coupled to computer system(s) 102 as shown by the dashed line in FIG. 1 by any suitable transmission media, which may include any suitable wired and/or wireless transmission media known in the art. Two or more of such computer systems may also be effectively coupled by a shared computer-readable storage medium (not shown).

The output generation subsystem may also be configured as an electron beam imaging system. In an electron beam imaging system, the energy directed to the specimen includes electrons, and the energy detected from the specimen includes electrons. As shown in FIG. 2, for example, the imaging system includes electron column 122, and the system includes computer system 124 coupled to the electron column. Computer system 124 may be configured as described above. In addition, such an imaging system may be coupled to another one or more computer systems in the same manner described above and shown in FIG. 1.

As also shown in FIG. 2, the electron column includes electron beam source 126 configured to generate electrons that are focused to specimen 128 by one or more elements 130. The electron beam source may include, for example, a cathode source or emitter tip, and one or more elements 130 may include, for example, a gun lens, an anode, a beam limiting aperture, a gate valve, a beam current selection aperture, an objective lens, and a scanning subsystem, all of which may include any such suitable elements known in the art.

Electrons returned from the specimen (e.g., secondary electrons) may be focused by one or more elements 132 to detector 134. One or more elements 132 may include, for example, a scanning subsystem, which may be the same scanning subsystem included in element(s) 130.

The electron column may include any other suitable elements known in the art. In addition, the electron column may be further configured as described in U.S. Pat. Nos. 8,664,594 issued Apr. 4, 2014 to Jiang et al., 8,692,204 issued Apr. 8, 2014 to Kojima et al., 8,698,093 issued Apr. 15, 2014 to Gubbens et al., and 8,716,662 issued May 6, 2014 to MacDonald et al., which are incorporated by reference as if fully set forth herein.

Although the electron column is shown in FIG. 2 as being configured such that the electrons are directed to the specimen at an oblique angle of incidence and are scattered from the specimen at another oblique angle, the electron beam may be directed to and scattered from the specimen at any suitable angles. In addition, the electron beam imaging system may be configured to use multiple modes to generate output for the specimen as described further herein (e.g., with different illumination angles, collection angles, etc.). The multiple modes of the electron beam imaging system may be different in any output generation parameters of the imaging system.

Computer system 124 may be coupled to detector 134 as described above. The detector may detect electrons returned from the surface of the specimen thereby forming electron beam images of (or other output for) the specimen. The electron beam images may include any suitable electron beam images. Computer system 124 may be configured to detect defects on the specimen using output generated by detector 134, which may be performed as described further herein. Computer system 124 may be configured to perform any additional step(s) described herein. A system that includes the imaging system shown in FIG. 2 may be further configured as described herein.

FIGS. 1 and 2 are provided herein to generally illustrate configurations of an output generation subsystem that may be included in the system embodiments described herein. Obviously, the output generation subsystem configurations described herein may be altered to optimize the performance of the output generation subsystem as is normally performed when designing a commercial system. In addition, the systems described herein may be implemented using an existing system (e.g., by adding functionality described herein to an existing inspection system) such as the tools that are commercially available from KLA Corp., Milpitas, Calif. For some such systems, the methods described herein may be provided as optional functionality of the system (e.g., in addition to other functionality of the system). Alternatively, the output generation subsystem described herein may be designed “from scratch” to provide a completely new system.

Although the output generation subsystem is described above as being a light or electron beam system, the output generation subsystem may be an ion beam system. Such a system may be configured as shown in FIG. 2 except that the electron beam source may be replaced with any suitable ion beam source known in the art. In addition, the output generation subsystem may include any other suitable ion beam imaging system such as those included in commercially available focused ion beam (FIB) systems, helium ion microscopy (HIM) systems, and secondary ion mass spectroscopy (SIMS) systems.

As further noted above, the output generation subsystem may be configured to have multiple modes. In general, a “mode” is defined by the values of parameters of the output generation subsystem used to generate images for the specimen. Therefore, modes that are different may be different in the values for at least one of the output generation parameters (other than position on the specimen at which the output is generated). For example, the modes may be different in any one or more alterable parameters (e.g., illumination polarization(s), angle(s), wavelength(s), etc., detection polarization(s), angle(s), wavelength(s), etc.) of the output generation subsystem. The output generation subsystem may be configured to scan the specimen with the different modes in the same scan or different scans, e.g., depending on the capability of using multiple modes to scan the specimen at the same time.

In a similar manner, the electron beam subsystem may be configured to generate images with two or more modes, which can be defined by the values of parameters of the electron beam subsystem used for generating images for a specimen. Therefore, modes may be different in the values for at least one of the electron beam parameters of the electron beam subsystem. For example, different modes may use different angles of incidence for illumination.

The output generation subsystem may be configured as an inspection subsystem as described above and/or a metrology subsystem or a defect review subsystem. For example, the embodiments of the output generation subsystem shown in FIGS. 1 and 2 may be modified in one or more parameters to provide different capability depending on the application for which it will be used. In one such example, the output generation subsystem may be configured to have a higher resolution if it is to be used for metrology rather than for inspection. In other words, the embodiments of the output generation subsystem shown in FIGS. 1 and 2 describe some general and various configurations for an output generation subsystem that can be tailored in a number of manners that will be obvious to one skilled in the art to produce systems having different capabilities that are more or less suitable for different applications.

In this manner, the output generation subsystem may be configured for generating output that is suitable for re-detecting defects on the specimen in the case of a defect review system and for measuring one or more characteristics of the specimen in the case of a metrology system. In a defect review system embodiment, computer subsystem 124 shown in FIG. 2 may be configured for re-detecting defects on specimen 128 by applying a defect re-detection method to the output generated by detector 134 and possibly determining additional information for the re-detected defects using the output generated by the detector. In a metrology system embodiment, computer subsystem 36 shown in FIG. 1 may be configured for determining one or more characteristics of specimen 14 using the output generated by detectors 28 and/or 34.

As noted above, the output generation subsystem is configured for scanning energy (e.g., light, electrons, etc.) over a physical version of the specimen thereby generating output for the physical version of the specimen. In this manner, the output generation subsystem may be configured as an “actual” subsystem, rather than a “virtual” subsystem. However, a storage medium (not shown) and computer system(s) 102 shown in FIG. 1 may be configured as a “virtual” system. In particular, the storage medium and the computer subsystem(s) may be configured as a “virtual” inspection system as described in commonly assigned U.S. Pat. Nos. 8,126,255 issued on Feb. 28, 2012 to Bhaskar et al. and 9,222,895 issued on Dec. 29, 2015 to Duffy et al., which are incorporated by reference as if fully set forth herein. The embodiments described herein may be further configured as described in these patents.

The system includes a computer system, which may include any configuration of any of the computer subsystem(s) or system(s) described above. The computer system is configured for acquiring output generated for a specimen by one or more detectors of an output generation subsystem. Acquiring the output performed by the computer system may or may not include generating the detector output, e.g., using an output generation subsystem configured as described herein. Instead, the computer subsystem may acquire the detector output from a storage medium in which it has been stored or from another method or system that generates the detector output. In this manner, the computer subsystem may acquire the detector output by retrieving or receiving it from another method or system. Therefore, one system may generate the detector output described herein, and the system described herein may determine information for a specimen from the detector output as described further herein. However, one system may be configured for performing all or at least some of these functions. In this manner, the embodiments described herein may be configured to perform the steps described herein off-tool or on-tool.

The system also includes one or more components executed by the computer system. For example, as shown in FIG. 1, the system may include computer system 36 and one or more components 104 executed by the computer system. The computer system may execute the components by inputting the acquired detector output and/or other kinds of inputs described herein into the component(s). The term “component” as used herein can be generally defined as any software and/or hardware that can be executed by a computer system. The component(s) may have different forms such as an algorithm, a model, a method, and combinations thereof. More generally, a component as that term is used herein is any element into which a computer system can input a specimen image, data, information, etc. and that is configured to determine information for a specimen from the input(s). Although some exemplary examples of components are described herein, it will be obvious to one of ordinary skill in the art that the component may vary depending on the application for which it will be used, e.g., the specimen itself, the information being determined for the specimen, the imaging tool that generated the input images, etc.

The one or more components include a DL model configured for determining information for the specimen from the output generated by at least one of the one or more detectors. Generally speaking, “deep learning” (also known as deep structured learning, hierarchical learning or deep machine learning) is a branch of ML based on a set of algorithms that attempt to model high level abstractions in data. In a DL-based model, there are typically many layers between the input and output, allowing the algorithm to use multiple processing layers, composed of, for example, multiple linear and non-linear transformations. DL methods are based on learning representations of data. In one such example, an observation (e.g., an image) can be represented in many ways such as a vector of intensity values per pixel, or in a more abstract way as a set of edges, regions of particular shape, etc.

A DL model can also be generally defined as a model that is probabilistic in nature. In other words, a DL model is not one that performs forward simulation or rule-based approaches and, as such, a model of the physics of the processes involved is not necessary. Instead, as described further herein, the DL model can be learned (in that its parameters can be learned) based on a suitable training set of data.

In one embodiment, the DL model is configured as a DL NN. For example, the DL model may have or include any suitable DL architecture such as any convolutional neural network (CNN) architecture known in the art. If the DL model is or includes a CNN, the CNN may include any suitable types of layers such as convolution, pooling, fully connected, soft max, etc., layers having any suitable configuration known in the art.

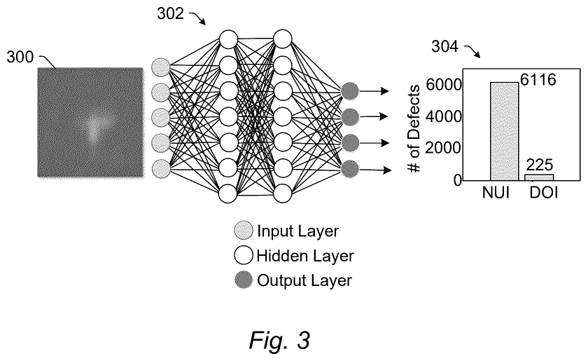

FIG. 3 shows one example of a DL NN configured for separating NUI from DOI and the data flow of the DL NN. Defect patch images, e.g., defect patch image 300, may be input to input layer of DL NN 302. The image content of the defect patch images constitutes the input layer. DL NNs typically include several hidden layers such as convolution or fully connected layers. Although only 2 hidden layers are shown in FIG. 3, the DL NN may include any suitable number of hidden layers, i.e., more than two. Finally, the output layer is the classification of the defect images into several groups, which may be output as (or used to generate) any suitable defect classification result such as bar chart 304. In the example given, the output groups are nuisance defects labeled NUI and defects of interest labeled DOI.

If the DL model is configured for defect classification, the DL model may be further configured as described in U.S. Pat. Nos. 10,043,261 issued Aug. 7, 2018 to Bhaskar et al., 10,360,477 issued Jul. 23, 2019 to Bhaskar et al., 10,607,119 issued Mar. 31, 2020 to He et al., and 11,580,398 issued Feb. 14, 2023 to Zhang et al., which are incorporated by reference as if fully set forth herein. The embodiments described herein may be further configured as described in these patents.

The DL model includes hidden layers configured for generating hidden layer output. Layers other than the input and output layers of a DL model are considered hidden layers or intermediate layers. Each of the hidden layers generates some output that is input to another layer in the model, and all of such output is referred to herein as hidden layer output. The output of hidden layers are however not output in the same manner as output of the output layer of the DL model. For example, hidden layer output is generally not useful to users in the same way specimen information generated by the output layer is. In one such example, the hidden layer output may be used by the DL model to determine a defect classification, which is output by the output layer, but the hidden layer output is not in of itself a defect classification. Therefore, while the hidden layer output is useful for determining the specimen information such as defect classifications, the hidden layer output is not important to users and is not, in of itself, information that is useful for users. As described herein, however, the inventors have created a new way to use the hidden layer output to improve specimen information determination processes.

The output generated by at least one of the one or more detectors that is input to and/or used by the DL model may include any detector output described herein of any of the detectors described herein. For example, the detector output that is input to the DL model may include optical or electron images generated for a defect detected on the specimen. In this manner, the detector output may include relatively small images, i.e., image patches, grabbed at locations of defects detected on the specimen during inspection. The detector output may also include the raw detector output and/or the raw detector output that has been processed in some manner. For example, the defect detection may include generating a difference image by subtracting a reference image from a specimen image and performing defect detection based on the difference image. Any combination of such images may be input to the DL model. The raw detector output and the images described above may also or alternatively be processed in other ways such as high pass filtering, spatial filtering, etc. prior to being input to the DL model.

The input to the DL model is also not limited to the output generated by at least one of the one or more detectors. For example, the DL model input may also include other information for the specimen such as design images and/or reference image(s) for the specimen. In general, however, the DL models described herein are configured for primarily or only having input channels for image-type inputs.

The DL models described herein may be trained in a variety of different ways. For example, the computer system described herein may be configured for training a DL model in a supervised manner using a training dataset that includes training images and labeled assigned to the images. In general, the training may include inputting the training images into the DL model and altering one or more parameters of the DL model until the DL model output matches (or substantially matches) the training labels. Training may, of course, be much more complicated than that and the type of training may be selected based on the configuration used for implementation of the embodiments described herein. Other types of training may also be used such as unsupervised training, self-supervised training, and the like. The embodiments described herein may therefore be configured to train the DL model used in the embodiments described herein. However, another method or system may train the DL model that is then used in the embodiments described herein.

The component(s) also include an additional component configured for determining additional information for the specimen from the hidden layer output generated by at least one of the hidden layers in combination with input specific to the specimen. In this manner, the embodiments described herein combine the strengths of multiple classification methods to improve on the overall accuracy of the defect classification or other process. In particular, a DL model (e.g., a DL NN) is used in combination with another component (e.g., an RF decision tree classifier), where the output of a hidden layer of the DL model is used as input to the RF along with other information described further herein such as defect attributes, which may be determined or derived from the specimen regions, image segmentation, detection algorithm settings, etc.

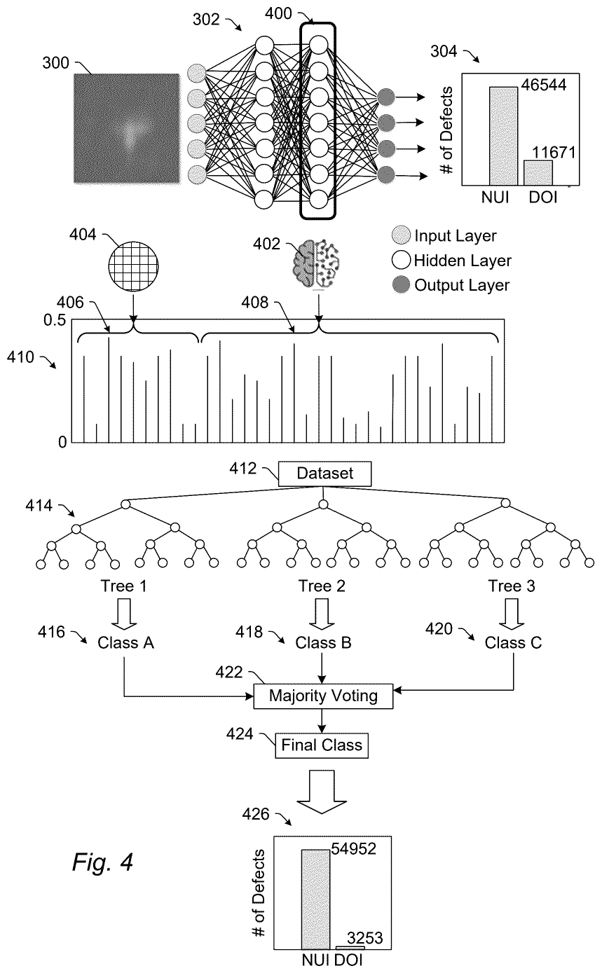

FIG. 4 shows a data flow of the combined components described herein, e.g., a combined NN and RF classifier. The DL model shown in this figure may be configured as described above and elements that may be similarly configured are labeled with the same reference numerals.

In one embodiment, the information determined for the specimen by the DL model is not input to the additional component. For example, as shown in FIG. 4, DL model 302 may generate defect classification results 304, but those results are not input to additional component 414. The DL model does not have to be configured to generate or output any results, but if it does generate results, the results may simply be discarded because the combined DL model and additional component will generate better results than the DL model alone.

As further shown in FIG. 4, instead of the output of the final layer of the DL model being input to additional component 414, hidden layer output 402 (shown schematically as neural activations in FIG. 4 only to convey the type of output that it is) generated by hidden layer 400 of DL model 302 is combined with input 404 specific to the specimen (shown schematically as a wafer map in FIG. 4 only to convey the type of input that it may be) and input to additional component 414.

In an additional embodiment, the at least one of the hidden layers includes a final fully connected layer in the DL model. For example, hidden layer 400 is the final fully connected layer in the DL model. In this manner, the hidden layer output of the last fully connected layer in the network may be extracted and used as input to the additional component. In one such embodiment, the activation of the final fully connected layer in the NN is used as the input to the second, RF classifier. As such, hidden layer output of the DL NN is used as the input to the RF classifier, which is then used to separate nuisance defects from DOIs.

In some embodiments, the DL model is configured for determining the information by distillation of the output generated by the at least one of the one or more detectors to a number of pertinent features of the output, and the hidden layer output input to the additional component includes activations of a final fully connected layer in the DL model responsive to the distillation. For example, the DL NN methods described herein generally include several convolution layers as well as fully connected layers. Defect patch images input to the DL model typically include several thousand pixels. Convolution layers apply several sets of filters to reduce that number to a smaller set of features. The fully connected layers tease out the correlations between these features. The last layer in the NN then calculates the probability that a given defect falls into one of the classification bins.

In this manner, the activation of the last fully connected layer in the network can be viewed as a distillation of the images down to a manageable number of pertinent features in the images, from which the final classification in the output layer is derived. More generally though, the “activation” is defined herein as the response of the network to an input image. During training, the weights and biases of each layer may be optimized. Then, when an image is input to the network, the activation is essentially a convolution of the image with the weights of the layer.

A major innovation in the embodiments described herein is the use of the intermediate result from the last fully connected layer as an input to the RF classification method, rather than the final classification output from the NN. The activation of the last fully connected layer constitutes a distillation of all the most pertinent image features. In this manner, the hidden layer output that is input to the additional component may include activations of at least one of the hidden layers of the DL model. However, the hidden layer output that is input to the additional component may also or alternatively include any other output of the hidden layer(s) including layers other than or in addition to the final fully connected layer.

Although the output of the final fully connected layer in the DL model may be most suitable for use as the hidden layer output in the embodiments described herein, the output of this layer and only this layer does not need to be used in the embodiments described herein. For example, the hidden layer output used in the embodiments described herein may be the output of a different intermediate layer in the DL model such as a different convolutional layer. In addition, the hidden layer output used in the embodiments described herein may include output generated by more than one intermediate layer in the same DL model. For example, one suitable DL model configuration may include a set of convolution layers that “concentrate” the images down to a smaller number of features that are then fed into fully connected layers. It is conceivable that the hidden layer output of one or more of such convolution layers may be input with the hidden layer output of one or more of the fully connected layers into the additional component as described further herein.

The DL models described herein also do not necessarily include any fully connected layers. For example, a DL model that makes some decision regarding an input, e.g., classifying an image as containing a defect or not, classification of an image as an image of one type of defect or another, may in general include at least one fully connected layer. However, the DL model may be configured for a different function, such as transforming an image from one resolution to another or transforming one image type to a different image type. Such DL models do not necessarily include fully connected layers. Such DL models may however also yield hidden layer output that can be useful in the same manner described herein as fully connected layer output. For example, the hidden layers of such DL models may also distill detector output to a number of pertinent features of the output, and the hidden layer output input to the additional component as described herein may include activations of any of the hidden layers in the DL model responsive to the distillation.

The hidden layer output may also include output generated by one or more intermediate layers in two or more DL models. For example, the components described herein may include multiple DL models (not shown). The multiple DL models may be configured to have the same or different architectures. Different architectures may yield more information, but DL models having the same architectures may be trained differently and/or learn differently and so may also be useful. In addition, the multiple DL models may be configured for determining the same kinds of information or different kinds of information. For example, the multiple DL models may include two DL models, both configured for defect classification. In a different example, the multiple DL models may include one DL model configured for defect classification and another DL model configured for defect detection, image transformation, or determining metrology type information for detected defects. The multiple DL models may be configured in parallel or series. In any of such configurations, the hidden layer output that is input to the additional component may include the hidden layer output from one or more intermediate layers in one DL model and the hidden layer output from one or more intermediate layers in at least one other DL model.

The input specific to the specimen may include any information specific to the specimen that is useful for defect classification or another function for which the system is configured. In general, the information specific to the specimen that is input to the additional component may include any specimen information that is available prior to the time the additional component generates information for the specimen. Such information may be generated by the process in which the detector output was generated, generated by any prior process performed on the specimen, input by a user, etc. For example, in the case of defect classification, the input specific to the specimen may include any wafer and recipe-based attributes used in previous instantiations of any defect classifier used on, with, or by a wafer inspection tool, e.g., a LS defect inspection tool. In this manner, the complete input to the additional component may be a combination of the DL model based image attributes (hidden layer output) with any wafer and recipe-based attributes used in defect classification of defects detected by a defect inspection tool.

In one embodiment, the input specific to the specimen includes information for a region on the specimen at which the output was generated by the one or more detectors. Such information is one type of wafer and recipe-based attributes that may be input to the additional component. The information for the region on the specimen may include information such as if detector output was generated within a care area on a specimen, the type of care area detector output is generated within, a type of device region that the detector output is generated within, and the like. Such region information may be used directly to detect or classify defects on a specimen, i.e., as a defect attribute. Such region information may also or alternatively be used to determine one or more parameters of the information determination performed by the additional component, e.g., defining a threshold separating nuisances from DOIs based on the region in which a defect was detected.

In an additional embodiment, the input specific to the specimen includes information specific to at least one defect on the specimen generated by a defect detection algorithm applied to the output generated by the at least one of the one or more detectors. For example, a defect detection algorithm may generate a variety of information for defects detected by the defect detection algorithm, which may include, but is not limited to, a defect location, a defect test image, a defect reference image, a defect difference image, a defect size estimate, and the like. The information that is determined by any one defect detection algorithm may vary depending on, for example, the specimen being inspected, the defects that are intended to be detected, the inspection tool configuration, and the defect detection algorithm configuration. In general, the input specific to the specimen may include any output generated by a defect detection algorithm applied to detector output generated for the specimen.

In another embodiment, the input specific to the specimen includes information generated by a defect detection algorithm applied to the output generated by the at least one of the one or more detectors. For example, a defect detection algorithm may generate information not specifically related to individual defects detected on a specimen. Such information includes wafer-level information or defect population (or subpopulation) related information. In one such example, a defect detection algorithm may generate information responsive to all of the defects detected on a wafer, e.g., wafer-level information and/or at least some of the defects detected on a wafer, e.g., distribution of defects detected on a specimen, which may be a spatial distribution of the defects across some portion of the specimen or a distribution in some other defect attribute. Such information may also or alternatively include information that is specific to one or more defects detected on the specimen including the information described further above. More generally, the input specific to the specimen may include any information generated by a defect detection algorithm applied to the detector output generated for the specimen.

In a further embodiment, the input specific to the specimen includes a parameter of a defect detection algorithm applied to the output generated by the at least one of the one or more detectors. For example, some defect detection algorithms record the parameters that resulted in one or more defects being detected. Defect detection algorithms with adjustable and fixed parameters may both output the parameters. The defect detection algorithm parameters may be output by the algorithm on a defect-by-defect basis, for a population or sub-population of defects, or for a whole wafer. One example of such a defect detection parameter may be an auto-threshold value that was applied to the detector output and resulted in detected defects. Additional examples of such defect detection parameters include a characteristic of a noise cloud that was generated for defect detection and segmentation parameters that were applied to the noise cloud or detector output for defect detection. Generally speaking, the input specific to the specimen may include any parameters of the defect detection algorithm that resulted in one or more defects being detected on a specimen. The input specific to the specimen may also include any other parameters of the recipe used to generate the detector output such as parameters of the output generation subsystem, e.g., the imaging related parameters.

In some embodiments, the hidden layer output generated by the at least one of the hidden layers includes multiple different results, the input specific to the specimen includes multiple different inputs, and the additional component is configured for independently applying an importance to at least one of the multiple different results and the multiple different inputs prior to determining the additional information. The importance of the different results and the different inputs may be defined relative to other results and/or inputs, and so the importance may be a kind of relative importance of one input or result to another. The importances may be determined as part of the learning process of the RF that assigns such importances. The importances assigned to each of the results and/or inputs may also be a kind of weight that is learned as described above and then applied to the results and/or inputs during classification.

The computer system may be configured for generating a visualization aid such as a bar chart to give the user feedback on which attributes contribute the most to the classification process. For example, bar chart 410 shown in FIG. 4 shows portion 406 of attributes included in and/or determined from the input specific to the specimen and portion 408 of attributes included in and/or determined from the hidden layer output and relative importance (on the y axis of the bar chart) of each of the attributes assigned by the additional component. In this manner, bar chart 410 shows the importance of all of the attributes used in the additional component, with the input specific to the specimen, e.g., traditional wafer-level and recipe-based attributes, on the left and the DL model image-based attributes on the right. The attributes in portions 406 and 408 and their assigned relative importance may then be combined into dataset 412 and input to additional component 414.

In some embodiments, the additional component includes a RF decision tree. Such a decision tree may also be referred to as an RF classifier. For example, as shown in FIG. 4, additional component 414 may include a set of classification trees, e.g., Tree 1, Tree 2, and Tree 3. All of the decision trees in the RF may be applied to the entire dataset generated for each of the images. Each of the trees may be optimized for one defect classification, e.g., Tree 1 is configured for generating Class A output 416, Tree 2 is configured for generating Class B output 418, and Tree 3 is configured for generating Class C output 420. Although three tress having a particular configuration are shown in FIG. 4, the RF decision tree may have any other suitable configuration known in the art.

A majority vote of all of the trees makes up the final classification of the defects. For example, Class A output 416, Class B output 418, and Class C output 420 for any one defect may be input to majority voting step 422, which may be configured to generate final class determination 424 for that defect. After all of the defects have been assigned a final class, the additional component, the computer system, or another component (not shown) may be configured to generate defect classification results 426, which in this instance are shown as a bar chart indicating the numbers of defects assigned DOI and NUI classifications.

In another embodiment, the additional component is configured so that the output of the detector(s) cannot be input to the additional component. For example, additional components such as the RF classifiers and others described herein are not capable of having images as input. Instead, such components are generally configured for classifying defects based on some attributes determined from or related to the defects. Those attributes can be quantitative or qualitative, but are still not the images themselves. As such, the additional components described herein are limited in some respect because they can only use predefined attributes determined from or related to images. The additional components cannot take the images themselves as inputs or learn from the images. However, the DL models described herein can learn from images and take the images themselves as inputs. Combining two classification methods as described herein for improved defect separation is therefore provided herein by using the hidden layer output of the first image-based (e.g., NN) classifier combined with the attribute-based information for the specimen as input to the second stage defect classifier (e.g., an RF classifier).

The DL models and additional components described herein are therefore configured for different types of inputs, e.g., images for DL models and inputs other than images for the additional components. Therefore, the different classifiers can use different information for the specimen to classify defects and will therefore generate different results as described further herein. The embodiments described herein take advantage of this fact by combining the different defect classifiers thereby increasing the types of inputs that are used for defect classification as well as combining the capabilities of the different defect classifiers. For example, by inputting the hidden layer output of the DL model into a different defect classifier along with any input normally input to the different defect classifier, the different defect classifier will most likely generate better defect classification results (e.g., more accurate and pure results) than those generated by 1) the DL model alone and 2) the different defect classifier without the hidden layer output.

In another embodiment, the additional component is configured as a non-DL model. For example, an RF decision tree may be considered a kind of ML defect classifier in the sense that the computer system may optimize (learn) the best settings for the decision tree over use, but it is not a DL model. Therefore, the RF decision trees described herein may be one of such non-DL models. The additional component may also be a different kind of non-DL model such as another decision tree type defect classifier, a rules based defect classifier, or any other type of model or algorithm that can take as input the hidden layer output as described herein and use that input in combination with other input specific to the specimen to perform defect classification. In other words, the DL model used in the first stage of the classification may be purely image based, and the additional component used in the second stage may be configured for taking as input other attributes, which may be image attributes and/or other types of attributes described herein.

Additional examples of classifiers that may be used as the additional component in the embodiments described herein are described in U.S. Patent Application Publication Nos. 2015/0254832 by Plihal published Sep. 10, 2015, 2015/0262038 by Konuru published Sep. 17, 2015, 2016/0258879 by Liang et al. published Sep. 8, 2016, and 2017/0082555 by He et al. published Mar. 23, 2017, which are incorporated by reference as if fully set forth herein. The additional components described herein may be configured as described in these publications.

Although defect classification results 304 and 426 are shown in FIG. 4 as examples of the type of defect classification results that may be generated by the DL model and the additional component, the numbers shown in those bar charts are actual results that were generated by the inventors with a configuration described herein. In particular, defect classification results 304 were generated by the DL model alone, and defect classification results 426 were generated by the additional component using the combined hidden layer output of the DL model and input specific to the specimen. The two bar charts show the classification of the defects found in a test set used in validation of the embodiments described herein. In the output generated by the DL model alone, about one fourth or 25% of all detected defects in the test set are classified as DOI. However, a much smaller percentage of all defects are expected to be important to the users. In other words, the number of defects classified as DOI is much higher than expected which indicates that those results most likely have relatively limited accuracy and purity. In bar chart 426 generated by the combination of the DL model and the additional component, only about 5% of the defects in the same test set are classified as DOI, which indicates a significantly improved purity and accuracy of the classification process.

The embodiments described herein combine the strengths and advantages of several defect classification methods. More particularly, the combined strength of the DL model (NN) and additional component (RF classification method) is a significant improvement over other existing classification methods. In the first stage, the DL model may be trained on a set of labelled defect images. Instead of simply using the final DL model classification bin as an input to the additional component, the activation of the final fully connected layer may be used as input to the additional component. The hidden layer output of the DL model may be fed directly into the additional component, e.g., the RF decision tree. This extra step improves the accuracy of the DL model and additional component by a further 10% or more. In particular, the power of the two methods combined as described herein improves the defect classification accuracy by an average of 10% and in some instances by as much as 25%.

Improved defect classification allows the consumer of the inspection results to better sample the DOIs, which are then typically reviewed on a scanning electron microscope (SEM) tool. SEM tool time is typically a precious commodity. Therefore, a higher sampling purity allows for a more streamlined review process, which is a substantially important step in the overall process control of semiconductor manufacturing. In addition, the embodiments described herein can be used for classification of defects detected by any existing or future inspection tools including any of those described herein and the results can be used for defect review sampling and/or review itself on any type of defect review tool including, but not limited to, SEMs.

In one embodiment, the information and the additional information are the same type of information. For example, in one embodiment, the information and the additional information include classifications of defects detected on the specimen. In another embodiment, the information and the additional information include classifications of defects detected on the specimen as DOIs or nuisances. More specifically, as shown in FIG. 4, both the DL model and the additional component may be configured for classifying defects as DOI or NUI. The DL model and the additional component may both be configured for another type of defect classification as described herein. In another example, both the DL model and the additional component may be configured for determining metrology information for the specimen. In addition, both the DL model and the additional component may be configured for determining the same type of metrology information for the specimen, e.g., line width measurements.

In other embodiments, the information and the additional information are different kinds of information. For example, although it may make sense for both the DL model and the additional component to be configured for determining the same type of information that is not necessary. In one such example, the DL model may be configured for transforming relatively low resolution images generated by inspection into higher resolution images without performing any type of defect classification, while the additional component may be configured for performing defect classification. In another such example, one DL model may be configured for defect detection, another DL model may be configured for defect classification, and hidden layer output from at least one layer in both DL models may be input to an additional component configured for defect classification. Therefore, the type of information determined by the additional component is different from the type of information determined by at least one of the DL models.

The computer system may also be configured for generating results that include the determined information, which may include any of the results or information described herein. The results of determining the information may be generated by the computer system in any suitable manner. All of the embodiments described herein may be configured for storing results of one or more steps of the embodiments in a computer-readable storage medium. The results may include any of the results described herein and may be stored in any manner known in the art. The results that include the determined information may have any suitable form or format such as a standard file type. The storage medium may include any storage medium described herein or any other suitable storage medium known in the art.

After the results have been stored, the results can be accessed in the storage medium and used by any of the method or system embodiments described herein, formatted for display to a user, used by another software module, method, or system, etc. to perform one or more functions for the specimen or another specimen of the same type. In addition, the results may include any information for the specimen determined as described herein.

That information may be used by the computer system or another system or method for performing additional functions for the specimen. Such functions include, but are not limited to, altering a process such as a fabrication process or step that was or will be performed on the specimen in a feedback or feedforward manner, etc. For example, the computer system may be configured to determine one or more changes to a process that was performed on the specimen and/or a process that will be performed on the specimen based on the determined information. The changes to the process may include any suitable changes to one or more parameters of the process. In one such example, the computer system preferably determines those changes such that any determined parameter values that are outside of an acceptable range of values are corrected on other specimens on which the revised process is performed, are corrected on the specimen in another process performed on the specimen, are compensated for in another process performed on the specimen, etc. The computer system may determine such changes in any suitable manner known in the art.

Those changes can then be sent to a semiconductor fabrication system (not shown) or a storage medium (not shown) accessible to both the computer system and the semiconductor fabrication system. The semiconductor fabrication system may or may not be part of the system embodiments described herein. For example, the output generation subsystem and/or the computer system described herein may be coupled to the semiconductor fabrication system, e.g., via one or more common elements such as a housing, a power supply, a specimen handling device or mechanism, etc. The semiconductor fabrication system may include any semiconductor fabrication system known in the art such as a lithography tool, an etch tool, a chemical-mechanical polishing (CMP) tool, a deposition tool, and the like.

Each of the embodiments described above may be combined together into one single embodiment. In other words, unless otherwise noted herein, none of the embodiments are mutually exclusive of any other embodiments.

Another embodiment relates to a computer-implemented method for determining information for a specimen. The method includes acquiring output generated for a specimen by one or more detectors of an output generation subsystem. The method also includes determining information for the specimen from the output generated by at least one of the one or more detectors with a DL model that includes hidden layers configured for generating hidden layer output. The method further includes determining additional information for the specimen by inputting the hidden layer output generated by at least one of the hidden layers in combination with input specific to the specimen into an additional component. The DL model and the additional component are included in one or more components executed by a computer system.

These steps may be performed according to any of the embodiments described herein. The method may also include any other step(s) that can be performed by the output generation subsystem, computer system, and/or components described herein. In addition, the method described above may be performed by any of the system embodiments described herein.

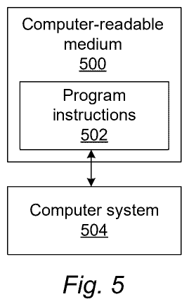

An additional embodiment relates to a non-transitory computer-readable medium storing program instructions executable on a computer system for performing a computer-implemented method for determining information for a specimen. One such embodiment is shown in FIG. 5. In particular, as shown in FIG. 5, non-transitory computer-readable medium 500 includes program instructions 502 executable on computer system 504. The computer-implemented method may include any step(s) of any method(s) described herein.

Program instructions 502 implementing methods such as those described herein may be stored on computer-readable medium 500. The computer-readable medium may be a storage medium such as a magnetic or optical disk, a magnetic tape, or any other suitable non-transitory computer-readable medium known in the art.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“MFC”), SSE (Streaming SIMD Extension), Python, Tensorflow, or other technologies or methodologies, as desired.

Computer system 504 may be configured according to any of the embodiments described herein.

Further modifications and alternative embodiments of various aspects of the invention will be apparent to those skilled in the art in view of this description. For example, methods and systems for determining information for a specimen are provided. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain attributes of the invention may be utilized independently, all as would be apparent to one skilled in the art after having the benefit of this description of the invention. Changes may be made in the elements described herein without departing from the spirit and scope of the invention as described in the following claims.

1. A system configured for determining information for a specimen, comprising:
a computer system configured for acquiring output generated for a specimen by one or more detectors of an output generation subsystem; and
one or more components executed by the computer system, wherein the one or more components comprise:
a deep learning model configured for determining information for the specimen from the output generated by at least one of the one or more detectors, wherein the deep learning model comprises hidden layers configured for generating hidden layer output; and
an additional component configured for determining additional information for the specimen from the hidden layer output generated by at least one of the hidden layers in combination with input specific to the specimen.

2. The system of claim 1, wherein the information determined for the specimen by the deep learning model is not input to the additional component.

3. The system of claim 1, wherein the additional component is further configured so that the output of the one or more detectors cannot be input to the additional component.

4. The system of claim 1, wherein the at least one of the hidden layers comprises a final fully connected layer in the deep learning model.

5. The system of claim 1, wherein the deep learning model is further configured for determining the information by distillation of the output generated by the at least one of the one or more detectors to a number of pertinent features of the output, and wherein the hidden layer output input to the additional component comprises activations of a final fully connected layer in the deep learning model responsive to the distillation.

6. The system of claim 1, wherein the information and the additional information comprise classifications of defects detected on the specimen.

7. The system of claim 1, wherein the information and the additional information comprise classifications of defects detected on the specimen as defects of interest or nuisances.

8. The system of claim 1, wherein the information and the additional information are a same type of information.

9. The system of claim 1, wherein the information and the additional information are different kinds of information.

10. The system of claim 1, wherein the deep learning model is further configured as a deep learning neural network.

11. The system of claim 1, wherein the additional component comprises a random forest decision tree.

12. The system of claim 1, wherein the additional component is further configured as a non-deep learning model.

13. The system of claim 1, wherein the input specific to the specimen comprises information for a region on the specimen at which the output was generated by the one or more detectors.

14. The system of claim 1, wherein the input specific to the specimen comprises information generated by a defect detection algorithm applied to the output generated by the at least one of the one or more detectors.

15. The system of claim 1, wherein the input specific to the specimen comprises information specific to at least one defect on the specimen generated by a defect detection algorithm applied to the output generated by the at least one of the one or more detectors.

16. The system of claim 1, wherein the input specific to the specimen comprises a parameter of a defect detection algorithm applied to the output generated by the at least one of the one or more detectors.

17. The system of claim 1, wherein the hidden layer output generated by the at least one of the hidden layers comprises multiple different results, wherein the input specific to the specimen comprises multiple different inputs, and wherein the additional component is further configured for independently applying an importance to at least one of the multiple different results and the multiple different inputs prior to determining the additional information.

18. The system of claim 1, further comprising the output generation subsystem, wherein the one or more detectors are configured for generating the output by detecting light or electrons from the specimen.

19. A non-transitory computer-readable medium, storing program instructions executable on a computer system for performing a computer-implemented method for determining information for a specimen, wherein the computer-implemented method comprises:
acquiring output generated for a specimen by one or more detectors of an output generation subsystem;
determining information for the specimen from the output generated by at least one of the one or more detectors with a deep learning model comprising hidden layers configured for generating hidden layer output; and
determining additional information for the specimen by inputting the hidden layer output generated by at least one of the hidden layers in combination with input specific to the specimen into an additional component, wherein the deep learning model and the additional component are included in one or more components executed by the computer system.

20. A computer-implemented method for determining information for a specimen, comprising:
acquiring output generated for a specimen by one or more detectors of an output generation subsystem;
determining information for the specimen from the output generated by at least one of the one or more detectors with a deep learning model comprising hidden layers configured for generating hidden layer output; and
determining additional information for the specimen by inputting the hidden layer output generated by at least one of the hidden layers in combination with input specific to the specimen into an additional component, wherein the deep learning model and the additional component are included in one or more components executed by a computer system.
